(19) United States
(12) Patent Application Publication
(10) Pub. No.: US 2024/0243967 A1
(43) Pub. Date: Jul. 18, 2024

(54) PROVIDING USER INITIATED CONFIGURATION FILE GENERATION AND USER INITIATED CONFIGURATION PUSH TO A NETWORK DEVICE

(71) Applicants: RAKUTEN MOBILE USA LLC, San Mateo, CA (US); Rakuten Symphony India Pte. Ltd., Indore, MP (IN); Rakuten Symphony Inc., Tokyo (JP)

(72) Inventors: Abhishek SINGH, San Mateo, CA (US); Anurag MAHAJAN, Indore (IN); Rahul GUPTA, Indore (IN); Aaditya DHARAMPURIKAR, Indore (IN); Karan ARORA, Tokyo (JP)

(21) Appl. No.: 18/005,353

(22) PCT Filed: Sep. 22, 2022
(86) PCT No.: PCT/US2022/044341

§ 371 Date: Jan. 13, 2023

(51) Int. Cl. H04L 41/0806; H04L 41/084

(52) U.S. Cl. CPC H04L 41/0806; H04L 41/084

(57) ABSTRACT

A configuration manager (CM) User Interface (UI) enables a user to initiate a configuration push by a configuration manager. A CM UI is displayed and accessed by a user. A network function device to configure is identified. A configuration file for configuring the network function device is provided to the CM using the CM UI. The user, form the CM UI, initiates a configuration push of the configuration file by the CM to the network function device to begin configuring the network function device.

### TECHNICAL FIELD

This description relates to a system, method, and non-transitory computer-readable media for providing user initiated configuration file generation and a user initiated configuration push to a network device.

### BACKGROUND

Newly developed software or applications go through an onboarding process. Part of the onboarding process involves pushing configuration files to the network service or device. An orchestrator is involved in the configuration and onboarding of network service and network functions based on descriptors, images and packages. Currently, a vendor or user relies on an orchestrator for configuration of dynamic parameters and for pushing the configuration file to the network service or device, whereas a configuration manager handles static parameters.

To push a configuration to a device or server, the user uploads the configuration file, e.g., Configuration Management Database (CMDB) and yang files. The orchestrator works with the configuration manager to provide parameters for configuring the network service or device. According to existing onboarding systems, the orchestrator sends a trigger signal to the configuration manager to initiate a configuration push. In response to receiving the trigger signal from the orchestrator to initiate the configuration push, the configuration manager generates a configuration file and pushes the configuration file to the network function or device.

Thus, the orchestrator is involved from the User Interface (UI) point of view for initiating the configuration push or triggering the configuration. The orchestrator relies on dynamic parameter visibility to control the configuration process and to provide a display of the status of the configuration process. However, the user is not able to control or initiate a configuration push to configure the function or device. The user is dependent upon the orchestrator to initiate the configuration push and depends on the orchestrator to visualize the current flow.

### SUMMARY

In at least embodiment, a method for enabling a user to initiate a configuration push by a configuration manager includes accessing a configuration manager (CM) User Interface (UI), determining a network function device to configure, providing a configuration file for configuring the network function device to the CM using the CM UI, and initiating, using the CM UI, a configuration push of the configuration file by the CM to the network function device to begin configuring the network function device.

In at least embodiment, a device for enabling a user to initiate a configuration push by a configuration manager includes a memory storing computer-readable instructions, and a processor connected to the memory, wherein the processor is configured to execute the computer-readable instructions to display a configuration manager (CM) User Interface (UI), receiving input identifying a network function device to configure. provide configuration file for configuring the network function device to the CM based on input provided to the CM UI, and initiate, from input received on the CM UI, a configuration push of the configuration file by the CM to the network function device to begin configuring the network function device.

In at least embodiment, a non-transitory computer-readable media having computer-readable instructions stored thereon, which when executed by a processor causes the processor to perform operations including accessing a configuration manager (CM) User Interface (UI), determining a network function device to configure, providing a configuration file for configuring the network function device to the CM using the CM UI, and initiating, using the CM UI, a configuration push of the configuration file by the CM to the network function device to begin configuring the network function device.

### BRIEF DESCRIPTION OF THE DRAWINGS

Aspects of the present disclosure are best understood from the following detailed description when read with the accompanying figures. It is noted that, in accordance with the practice in the industry, various features are not drawn to scale. In fact, the dimensions of the various features are able to be increased or reduced for clarity of discussion.

FIG. 1 illustrates a system for initiating a configuration push using an orchestrater.

FIG. 2 illustrates the signal flow of orchestrator initiated configuration push.

FIG. 3 illustrates a vendor initiation of a configuration push according to at least one embodiment.

FIG. 4 illustrates a Configuration Manager (CM) User Interface (UI) for provisioning a configuration file according to at least one embodiment.

FIG. 5 illustrates Configuration Provisioning UI for providing information associated with a configuration file according to at least one embodiment.

FIG. 6 illustrates a CM UI having a configuration file after the selection of the submit button according to at least one embodiment.

FIG. 7 is a flowchart of a method for providing user initiated configuration file generation and a user initiated configuration push to a network device according to at least one embodiment.

FIG. 8 is a high-level functional block diagram of a processor-based system according to at least one embodiment.

### DETAILED DESCRIPTION

Embodiments described herein describes examples for implementing different features of the provided subject matter. Examples of components, values, operations, materials, arrangements, or the like, are described below to simplify the present disclosure. These are, of course, examples and are not intended to be limiting. Other components, values, operations, materials, arrangements, or the like, are contemplated. For example, the formation of a first feature over or on a second feature in the description that follows include embodiments in which the first and second features are formed in direct contact and include embodiments in which additional features are formed between the first and second features, such that the first and second features are unable to make direct contact. In addition, the present disclosure repeats reference numerals and/or letters in the various examples. This repetition is for the purpose of simplicity and clarity and does not in dictate a relationship between the various embodiments and/or configurations discussed.

Further, spatially relative terms, such as “beneath,” “below,” “lower,” “above,” “upper” and the like, are used herein for ease of description to describe one element or feature's relationship to another element(s) or feature(s) as illustrated in the figures. The spatially relative terms are intended to encompass different orientations of the device in use or operation in addition to the orientation depicted in the FIGS. The apparatus is otherwise oriented (rotated 90 degrees or at other orientations) and the spatially relative descriptors used herein likewise are interpreted accordingly.

Terms “system” and “network” in embodiments of this application are used interchangeably. “At least one” means one or more, and “a plurality of” means two or more. The term “and/or” describes an association relationship between associated objects and indicates that three relationships exist. For example, A and/or B indicate the following cases: Only A exists, both A and B exist, and only B exists, where A and B is singular or plural. The character “/” generally indicates an “or” relationship between the associated objects. “At least one of” or a similar expression thereof means any combination of items, including any combination of singular items (pieces) or plural items (pieces). For example, “at least one of A, B, and C” includes A, B, C, AB, AC, BC, or ABC, and “at least one of A, B, or C” includes A, B, C, A and B, A and C, B and C, or A and B and C.

Terms like “user equipment,” “mobile station,” “mobile,” “mobile device,” “subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming data-stream or signaling-stream. The foregoing terms are utilized interchangeably in the subject specification and related drawings. The terms “access point,” “base station,” “Node B,” “evolved Node B (eNode B),” next generation Node B (gNB), enhanced gNB (en-gNB), home Node B (HNB),” “home access point (HAP),” or the like refer to a wireless network component or apparatus that serves and receives data, control, voice, video, sound, gaming data-stream or signaling-stream. from UE.

Embodiments described herein describes examples for implementing different features of the provided subject matter. Examples of components, values, operations, materials, arrangements, or the like, are described below to simplify the present disclosure. These are, of course, examples and are not intended to be limiting. Other components, values, operations, materials, arrangements, or the like, are contemplated. For example, the formation of a first feature over or on a second feature in the description that follows include embodiments in which the first and second features are formed in direct contact and include embodiments in which additional features are formed between the first and second features, such that the first and second features are unable to make direct contact. In addition, the present disclosure repeats reference numerals and/or letters in the various examples. This repetition is for the purpose of simplicity and clarity and does not in dictate a relationship between the various embodiments and/or configurations discussed.

Embodiments described herein enable a vendor/user to directly upload a configuration file and initiate a configuration push from a Configuration Manager (CM) User Interface (UI) based on the selection of the device and a respective IP and port for the device. For simplicity, the term “user” is used herein, but those skilled in the art recognize that the user includes a vendor that operates the CM UI. The user does not rely upon the orchestrator to perform the configuration push. The user is able to upload a configuration file or upload dynamic parameters directly for creation of a configuration file, and then initiate the configuration push. Enabling the user to perform the configuration push provides a semi-automated approach that provides the user more control over the configuration process. The user, through the CM UI, provides the configuration files and performs the configuration push from the UI without dependency on the orchestrator.

A UI is provided for users to onboard configuration files. A user is provided the option to choose to use a dynamic parameter file, an XML (Extensible Markup Language) configuration file, a JSON (JavaScript Object Notation) file, or templates to generate the configuration file. Once the configuration file is generated, the user is able to initiate the configuration push via the CM UI. The user also has the option to download the overall configuration to be pushed and to check the execution information. The user is also able to download day1 and day 2 configuration and to perform day1 and day 2 configuration push from the CM UI directly. The CM UI provides visualization and use cases that are fulfilled by the CM. The CM UI displays the status of the configuration process, e.g., whether the configuration was successful, and whether the configuration failed. Feedback about actions the user is able to take to complete the configuration are also displayed. The CM UI also allows the user to edit a configuration file or to delete a currently selected configuration file.

According to at least one embodiment, a method for enabling a user to initiate a configuration push by a configuration manager includes accessing a configuration manager (CM) User Interface (UI), determining a network function device to configure, providing a configuration file for configuring the network function device to the CM using the CM UI, and initiating, using the CM UI, a configuration push of the configuration file by the CM to the network function device to begin configuring the network function device.

Advantages include a savings of time, effort and cost involved in configuring a network service or device. Users do not depend on an orchestrator to trigger a configuration push of a configuration file to the network service or device. Users are able to trigger the configuration push using a Configuration Manager (CM) User Interface (UI).

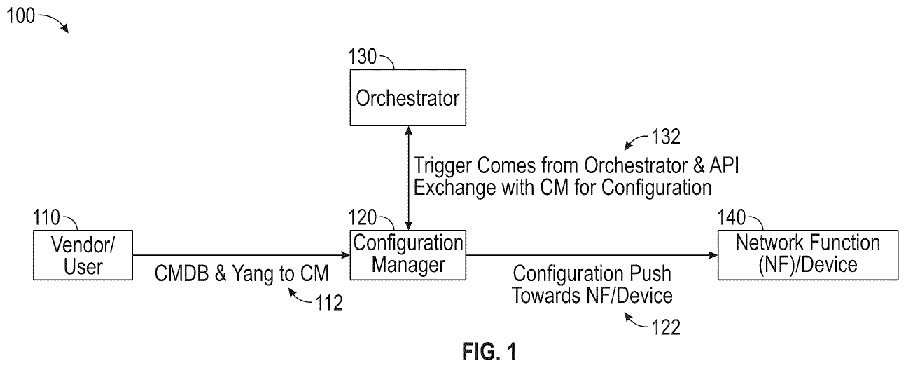

FIG. 1 illustrates a system 100 for initiating a configuration push using an orchestrater.

In FIG. 1, to push a configuration to a device or server, the Vendor/User 110 uploads the configuration file, e.g., Configuration Management Database (CMDB) and yang files 112, to a Configuration Manager 120. An Orchestrator 130 works with the Configuration Manager 120 to provide parameters for configuring the network service or device. The Orchestrator 130 sends a trigger signal 132 to the Configuration Manager 120 to initiate a Configuration Push 122 from the Configuration Manager 120 to a Network Function Device 140. In response to receiving the trigger signal 132 from the Orchestrator 130 to initiate the Configuration Push 122, the Configuration Manager 120 generates a configuration file and execute the Configuration Push 122 to the Network Function Device 140.

The Orchestrator 130 is involved from the User Interface (UI) point of view for initiating the Configuration Push 122 or triggering the configuration of the Network Function Device 140. The Orchestrator 130 relies on dynamic parameter visibility to control the configuration process and to provide a display of the status of the configuration process to the Vendor/User 110 by the Configuration Manager 130. However, the Vendor/User 110 is not able to control or initiate a configuration push 122 to configure the Network Function Device 140. The Vendor/User 110 is dependent upon the Orchestrator 130 to initiate the configuration push 122 and depends on the Orchestrator 130 to visualize the flow of the configuration process. However, vendors want a solution where the Vendor/User 110 does not depend on the Orchestrator 130 to initiate the Configuration Push 122.

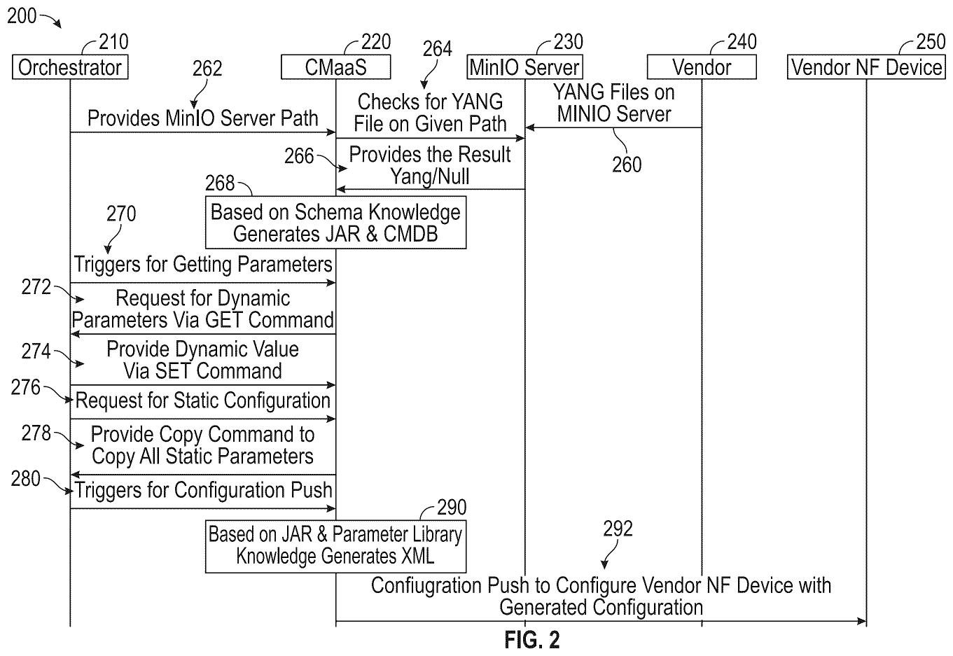

FIG. 2 illustrates the signal flow 200 of orchestrator initiated configuration push.

In FIG. 2, a prior configuration process is shown having the Orchestrator 210 providing a Trigger for a Configuration Push 280 to a configuration manager, e.g., Configuration Management as a Service (CMaaS) 220. Thus, the user is not able to directly upload dynamic parameters and initiate the configuration push from a configuration manager user interface. Here, a configuration provisioning system includes an Orchestrator 210, a Configuration Management as a Service (CMaaS) 220, a MinIO Server 230, a Vendor 240, and a Vendor Network Function Device 250. Vendor 240 provides YANG files 260 to MinIO Server 230. MinIO Server 230 is a high performance distributed object storage server. Orchestrator 210 provides the CMaaS 220 the MinIO Server path 262. CMaaS 220 checks the MinIO Server 230 for the YANG file on the given path 264. The MinIO Server 230 provides CMaaS 220 the YANG file from the given path 266. The CMaaS 220, based on schema knowledge, generates a JAR (Java ARchive) file and CMDB file 268.

The Orchestrator 210 sends a trigger 270 to CMaaS 220 for obtaining parameters for the configuration of the Vendor Network Function Device 250. CMaaS 220 sends Orchestrator 210 a request for dynamic parameters via a GET command 272. A GET command 272 obtains the specified dynamic parameters from Orchestrator 210. Orchestrator 210 provides to the CMaaS 220 the dynamic values via a SET command 274. Orchestrator 210 sends a requests for static configuration 276 from CMaaS 220. CMaaS 220 provides a copy command to copy the static parameters 278 to Orchestrator 210. Orchestrator 210 sends CMaaS 220 a trigger to initiate the configuration push 280. CMaaS 220 generates an XML configuration file 290 based on the JAR and parameter library knowledge. CMaaS 220 sends a Configuration Push 292 to Vendor Network Function Device 250 to configure the Vendor Network Function Device 250.

As described above with reference to FIG. 1, Orchestrator 210 is involved in initiating the Configuration Push 292 for configuring the Vendor Network Function Device 250. The Orchestrator 210 relies on dynamic parameter visibility to control the configuration process and to provide a display of the status of the configuration process to the Vendor 240 by CMaaS 220. However, the Vendor 240 is not able to control or initiate the Configuration Push 292 to configure the Vendor Network Function Device 250. The Vendor 240 is dependent upon the Orchestrator 210 to initiate the Configuration Push 292 and depends on the Orchestrator 210 to visualize the flow of the configuration process. However, vendors want a solution where the Vendor 240 does not depend on the Orchestrator 210 to initiate the Configuration Push 292.

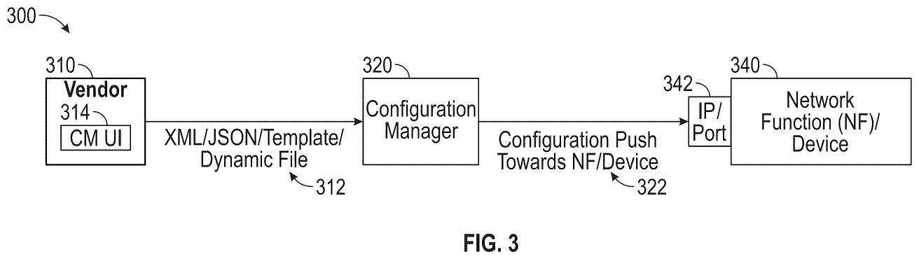

FIG. 3 illustrates a vendor initiation of a configuration push 300 according to at least one embodiment.

In FIG. 3, Vendor 310 sends XML file/JSON/Template/Dynamic Parameter file 312 to Configuration Manager (CM) 320. CM 320 initiates Configuration Push 322 toward Network Function (NF) Device 340.

In at least one embodiment, Vendor 310 uploads an XML (Extensible Markup Language) file 312 directly to CM 320 and initiates Configuration Push 322 using a Configuration Manager (CM) User Interface (UI) 314. In at least one embodiment, a JSON (JavaScript Object Notation) file is used for the configuration Push 322. Those skilled in the art recognized that embodiments described herein are not limited to a particular file type or file format and that other types of files are supported depending on what type of file a Vendor 310 uses. Herein, XML file 312 is used as an example. The Configuration Push 322 is based on the selection of the device and a respective IP address and port number 342 for the NF Device 340. For simplicity, the term “user” and “vendor” are used interchangeably. Vendor 310 does not rely upon an orchestrator to perform the Configuration Push 322. Vendor 310 uploads XML configuration file 312 or, alternatively, uploads dynamic parameters directly for creation of a configuration file. The CM UI 314 causes the CM 320 to initiate the Configuration Push 322. Enabling the Vendor 310 to initiate the Configuration Push 322 via the CM UI 314 provides a semi-automated approach that provides Vendor 310 more control over the configuration process. Vendor 310, through the CM UI 314, provides the configuration file 312 and causes CM 320 to initiate the Configuration Push 322 from the UI without dependency on an orchestrator.

CM UI 314 is provided for Vendor 310 to onboard configuration files. Vendor 310 is provided the option to choose to use a dynamic parameter file, an XML configuration file, or templates to generate the configuration file 312. Once the configuration file 312 is generated, Vendor 310 is able to initiate the Configuration Push 322 via the CM UI 314. Vendor 310 also has the option to download the overall configuration file 312 to be pushed and to check the execution information. Vendor 310 is also able to download day1 and day 2 configurations and to initiate a day1 and day 2 configuration push directly from CM UI 314.

CM UI 314 provides visualization and use cases that are fulfilled by the CM 320. The CM UI 314 displays the status of the configuration process, e.g., whether the configuration was successful, and whether the configuration failed. Feedback about actions the user is able to take to complete the configuration are also displayed. CM UI 314 also allows the Vendor 310 to edit configuration file 312 or to delete a currently selected configuration file 312.

Advantages provided by CM UI 314 of at least one embodiment include a savings of time, effort and cost. Vendor 310 also does not depend on an orchestrator. Vendor 310 is able to select to trigger the Configuration Push 322 by CM 320 from the CM UI 314.

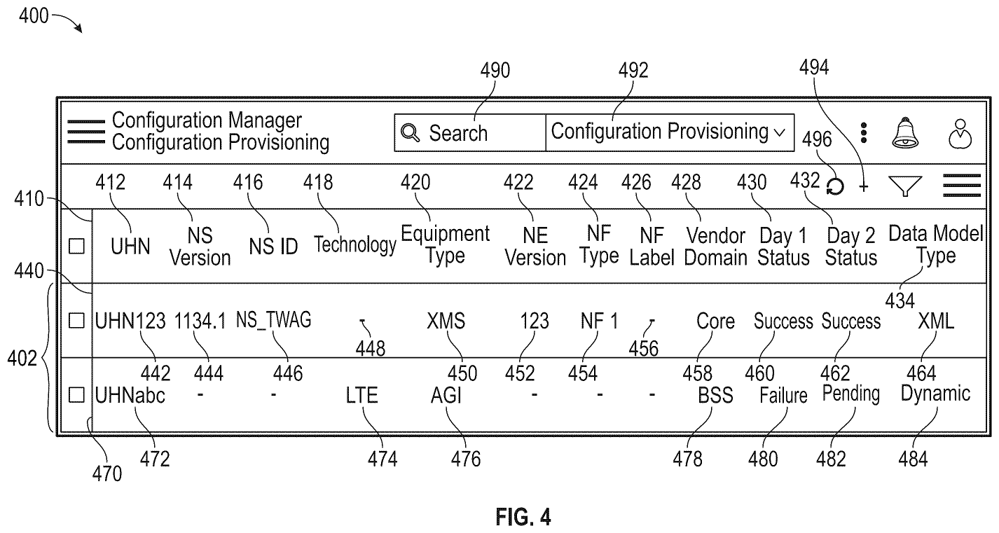

FIG. 4 illustrates a Configuration Manager (CM) User Interface (UI) 400 for provisioning a configuration file according to at least one embodiment.

In FIG. 4, CM UI 400 is displayed with Configuration Files 440, 470 in a Configuration File List 402. CM UI 400 presents a label row 410 for identifying parameters associated with a configuration file defined by the user. Label row 410 includes a Uniform Host Name (UHN) 412, a Network Service (NS) Version identifier 414, an NS ID 416, a Technology identifier 418, an Equipment Type identifier 420, a Network Element (NE) Version identifier 422, a Network Function (NF) Type identifier 424, an NF Label 426, a Vendor Domain identifier 428, a Day 1 Configuration Status 430, a Day 2 Configuration Status 432, and a Data Model Type identifier 434.

Data model types include an XML type, JSON type of data, and others. Instead of performing a configuration PUSH using an XML file, the user is able to select the JSON data type, where a JSON file is used to perform the configuration PUSH towards the device. The data model type informs the CM what type of data is going to be used. In addition, to XML type and JSON type, the CM is able to use different data model types based on different formats. UHN 412 is based on the network element listing and a synchronization from inventory UHN listing. The CM UI 400 selects a file based on the UHN 412, which is an identifier of the network elements

For example, CM UI 400 displays one or more Configuration Files 440, 470. Configuration File 440 has UHN of UHN123 442 identifying a network function device. Configuration File 440 is further shown having an NS Version identifier of 1134.1 444, and an NS ID of NS_TWAG (Trusted Wireless Access Gateway) 446. A Technology identifier is not provided 448 for UHN UHN123 442. The Equipment Type identifier is XMS 450, the NE Version identifier is 123 452, and the NF Type identifier is NF1 454. An NF Label is not provided 456 for UHN UHN123 442. The Vendor Domain identifier is Core 458, the Day 1 Configuration Status is Success 460, the Day 2 Configuration Status is Success 462, and the Data Model Type identifier is XML 464.

In the next row, Configuration File 470 has UHN of UHNabc 472. The Technology identifier is LTE 474, and the Equipment Type identifier is AG1 476. AG1 476 refers to an Aggregator Router. The Vendor Domain for UHN of UHNabc 472 is Base Station Subsystem (BSS) 478. The Day 1 Configuration Status is Failure 480, the Day 2 Configuration Status is Pending 482, and the Data Model Type identifier is XML 484. Thus, the user is able to visualize from CM UI 400 the status of the configuration process, e.g., whether the configuration was successful, whether the configuration failed, or whether the configuration push has particular issues or reasons for failure. In response to the particular issues or reasons for failure are presented, the user is able to address the issues by taking some action. Logs from the network element are being captured by the CM to provide the status information. The CM communicates directly with the network element, or the network device. The network element or network device communicates with the CM to provide details about the configuration push. Herein network function device refers to one or more of a network element or a network device.

A search may be executed by entering a search term 490 and selecting a search category, e.g., Configuration Provisioning 492. A configuration file is added by selecting the “+” or “add” button 494. The information is updated by selecting the refresh icon 496.

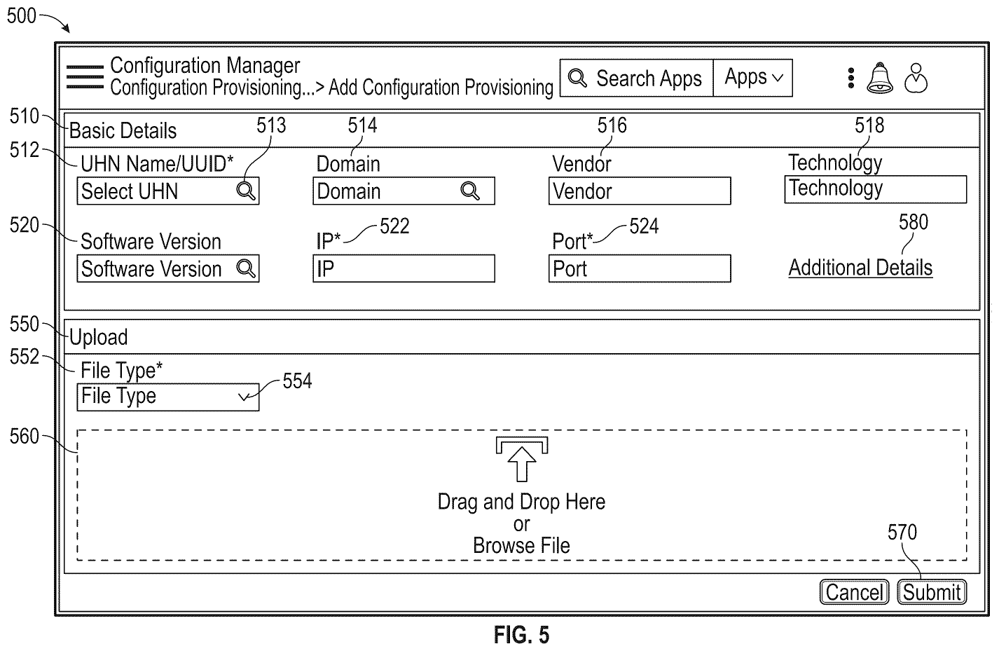

FIG. 5 illustrates Configuration Provisioning UI 500 for providing information associated with a configuration file according to at least one embodiment.

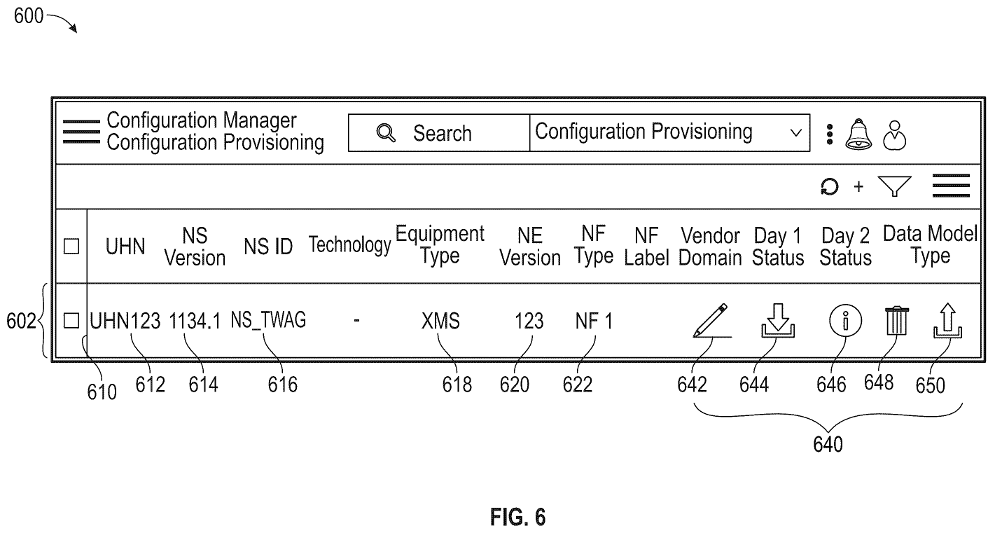

In FIG. 5, Configuration Provisioning UI 500 is displayed in response to selection of an “Add” button or an “Edit” button in CM UI 400 described with reference to FIG. 4. Configuration Provisioning UI 500 presents options for providing details and has different windows for providing the information in response to selecting an “edit” button (as described below with reference to FIG. 6) or the “+” or “add” button 494 on CM UI 400 described with reference to FIG. 4. Configuration Provisioning UI 500 includes an area for Basic Details 510 and an Upload area 550. The area for Basic Details 510 includes a window for selecting or entering a UHN Name/UUID (Universal Unique Identifier) 512. Configuration Provisioning UI 500 is also capable of performing a search 513 for the UHN Name/UUID 512.

A Domain window 514 is provided for the providing the Vendor Domain information. Configuration Provisioning UI 500 is also capable of performing a search from the Domain window 514 for the Vendor Domain information. A Vendor widow 516 is provided for entering the vendor information. A Technology window 518 is used to provide an identification for the specific technology associated with the UHN Name/UUID 512.

A Software Version window 520 enables the software version information to be entered. Configuration Provisioning UI 500 is also capable of performing a search from the Software Version window 520 for the software version information associated with the UHN Name/UUID 512. An IP Address window 522 and a Port Number window 524 enables a user to enter an IP address and Port Number, respectively, for the network element associated with the UHN Name/UUID 512 and which the configuration push is directed toward.

The Upload area 550 includes a File Type window 552 for identifying the type of configuration file associated with the UHN Name/UUID 512. File Type window 552 provides a drop-down menu 554 for selecting the type of configuration file associated with the UHN Name/UUID 512. From File Type window 552, a user is provided the option to choose to use a dynamic parameter sheet, an XML configuration file, or templates to generate the configuration file. An XML file is able to be created at the CM based on the user input through the dynamic parameter sheet or templates. Based on a JAR and parameter library knowledge, the CM generates the XML file.

A File Selection area 560 is provided for uploading the configuration file. As shown in File Selection area 560, the configuration file, such as an XML file, is able to be dragged and dropped or the user can click in the File Selection area 560 to browse for the configuration file. In response to the user generating the configuration file using templates or dynamic sheets, the user is able to download the generated configuration file and the user is able to initiate the configuration push using the configuration files using the options displayed in CM UI 400.

Once entry of the information associated with the configuration file has been completed, the user is able to select the Submit button 570 to submit the configuration file to the CM UI 400. The user is able to review the information associated with the configuration file from the Configuration Provisioning UI 400 described above with reference to FIG. 4. The user is also able to cancel the entry of the information associated with the configuration file.

Based on the information and based on the selection of file type, a user is able to enter data for the fields and save the configuration to be pushed. Additional options are available from Configuration Provisioning UI 500 by selecting Additional Details 580. For example, selecting Additional Details 580 enables the user to edit a configuration file, download a Day1 and Day 2 configuration, delete a configuration file, view execution status of the configuration file, and push Day1 and Day 2 configurations directly.

Thus, Configuration Provisioning UI 500 enables a user to onboard configuration files. For example, in at least one embodiment, the user uploads an XML file directly in File Selection area 560 and initiates a configuration push based on the selection of the device, e.g., entry of UHN in UHN/UUID window 512 and a respective IP Address in IP Address window 522 and a Port Number for the device in Port Number window 524. From File Selection are 560, a user is able to upload a configuration file or upload adynamic parameter sheet or templates directly for creation of a configuration file, and then initiate the configuration push. In response to the user generating the configuration file using templates or dynamic sheets, the user is able to upload the generated configuration file to the CM UI 400 where the user is able to initiate the configuration push using the configuration files. Enabling the user to perform the configuration push provides a semi-automated approach that provides the user more control over the configuration process. The user, through the Configuration Provisioning UI 500, provides the configuration files and performs the configuration push without dependency on the orchestrator.

FIG. 6 illustrates a CM UI 600 having a configuration file after the selection of the submit button according to at least one embodiment.

In FIG. 6, Configuration File 610 is displayed in a Configuration File List 602 in CM UI 600 in response to the selection of the submit button 570 in FIG. 5. Configuration File 610 is displayed as having been selected in CM UI 600 and includes UHN of UHN123 612. Again, configuration file having UHN of UHN123 612 is associated with NS Version identifier of 1134.1 614, and NS ID of NS_TWAG 616. The Equipment Type identifier is XMS 618, the NE Version identifier is 123 620, and the NF Type identifier is NF1 622. However, because configuration file having UHN of UHN123 612 has been selected, additional functions 640 are shown. For example, the Edit icon 642 is able to be selected to edit UHN123 612. The additional functions also include a Download icon 644 for downloading the submitted configuration file having UHN of UHN123 612.

Information icon 646 is able to be selected to provide to the user information about the configuration file to help with provisioning the configuration file. For example, feedback about actions the user is able to take to complete the configuration is displayed. Trash icon 648 allows a user to remove the configuration file from Configuration Provisioning UI 600. Upload icon 650 allows a user to upload Configuration File 610 having UHN of UHN123 612 to CM. Selection of the Upload Icon 650 initiates the configuration push of the configuration file to the network element. Thus, CM UI 600 allows the user to edit a configuration file or to delete a currently selected configuration file.

Thus, CM UI 600 provides the user the option to download the overall configuration to be pushed. Once the configuration file is generated, the user is able to initiate the configuration push via CM UI 600. CM UI 600 helps users to directly perform a configuration push and visualize the execution information as well. Users are able to use CM UI 600 in response to the orchestrator being absent, or in response to user wanting to perform the configuration directly.

CM UI 600 provides a savings of time, effort and money. Users also do not depend on the orchestrator to initiate a configuration push. Users are able to select triggering of the configuration push directly from CM UI 600. CM UI provides visualization and use cases that are fulfilled by the CM.

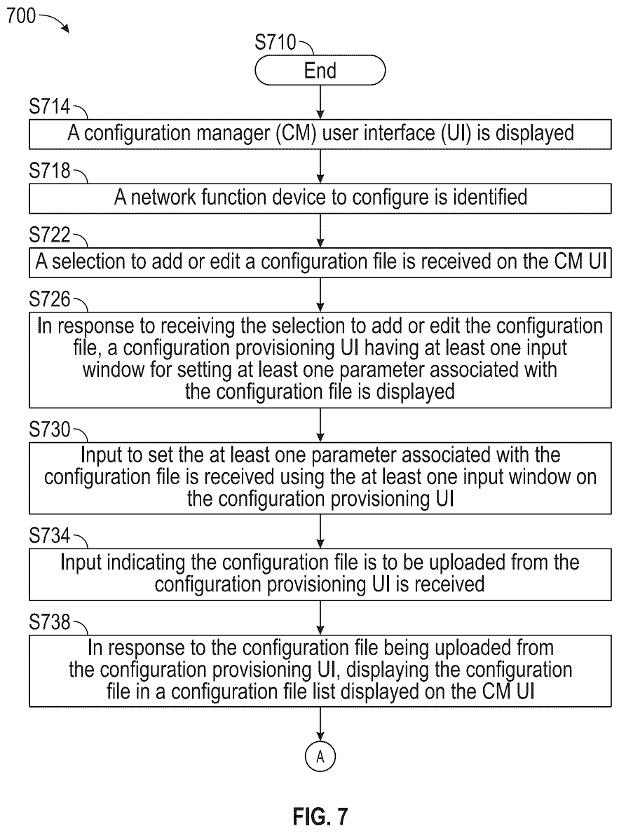

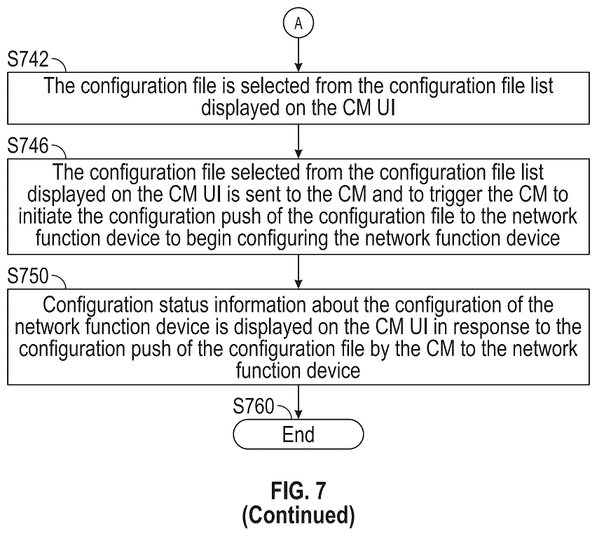

FIG. 7 is a flowchart 700 of a method for providing user initiated configuration file generation and a user initiated configuration push to a network device according to at least one embodiment.

In FIG. 7, the method starts S710 and a configuration manager (CM) User Interface (UI) is displayed S714. Referring to FIG. 4, CM UI 400 is displayed having a label row 410 for identifying parameters associated with a configuration file defined by the user. Label row 410 includes a Uniform Host Name (UHN) 412, a Network Service (NS) Version identifier 414, an NS ID 416, a Technology identifier 418, an Equipment Type identifier 420, a Network Element (NE) Version identifier 422, a Network Function (NF) Type identifier 424, an NF Label 426, a Vendor Domain identifier 428, a Day 1 Configuration Status 430, a Day 2 Configuration Status 432, and a Data Model Type identifier 434.

A network function device to configure is identified S718. Referring to FIG. 4, Configuration File 440 has UHN of UHN123 442 identifying a network function device.

A selection to add or edit a configuration file is received on the CM UI S722. Referring to FIG. 4, a configuration file is added by selecting the “+” button 494. Referring to FIG. 6, the Edit icon 642 is able to be selected to edit UHN123 612.

In response to receiving the selection to add or edit the configuration file, a Configuration Provisioning UI having at least one input window for setting at least one parameter associated with the configuration file is displayed S726. Referring to FIG. 5, Configuration Provisioning UI 500 is displayed in response to selection of an “Add” button or an “Edit” button in CM UI 400 described with reference to FIG. 4. Configuration Provisioning UI 500 presents options for providing details and has different windows for providing the information.

Input to set the at least one parameter associated with the configuration file is received using the at least one input window on the Configuration Provisioning UI S730. Referring to FIG. 5s, the area for Basic Details 510 includes a window for selecting or entering a UHN Name/UUID (Universal Unique Identifier) 512. Configuration Provisioning UI 500 is also capable of performing a search for the UHN Name/UUID 512. A Domain window 514 is provided for the providing the Vendor Domain information. Configuration Provisioning UI 500 is also capable of performing a search from the Domain window 514 for the Vendor Domain information. A Vendor widow 516 is provided for entering the vendor information. A Technology window 518 is used to provide an identification for the specific technology associated with the UHN Name/UUID 512. A Software Version window 520 enables the software version information to be entered. Configuration Provisioning UI 500 is also capable of performing a search from the Software Version window 520 for the software version information associated with the UHN Name/UUID 512. An IP Address window 522 and a Port Number window 524 enables a user to enter an IP address and Port Number, respectively, for the network element associated with the UHN Name/UUID 512 and which the configuration push is directed toward.

Input indicating the configuration file is to be uploaded from the Configuration Provisioning UI is received S734. Referring to FIG. 5, the Upload area 550 includes a File Type window 552 for identifying the type of configuration file associated with the UHN Name/UUID 512. File Type window 552 provides a drop-down menu 554 for selecting the type of configuration file associated with the UHN Name/UUID 512. From File Type window 552, a user is provided the option to choose to use a dynamic parameter sheet, an XML configuration file, or templates to generate the configuration file. An XML file is able to be created at the CM based on the user input through the dynamic parameter sheet or templates. Based on a JAR and parameter library knowledge, the CM generates the XML file. A File Selection area 560 is provided for uploading the configuration file. As shown in File Selection area 560, the configuration file, such as an XML file, is able to be dragged and dropped or the user can click in the File Selection area 560 to browse for the configuration file. In response to the user generating the configuration file using templates or dynamic sheets, the user is able to download the generated configuration file and the user is able to initiate the configuration push using the configuration files using the options displayed in CM UI 400. Once entry of the information associated with the configuration file has been completed, the user is able to select the Submit button 570 to submit the configuration file to the CM UI 400.

In response to the configuration file being uploaded from the Configuration Provisioning UI, displaying the configuration file in a configuration file list displayed on the CM UI S738. Referring to FIG. 6, Configuration File 610 is displayed in a Configuration File List 602 in CM UI 600 in response to the selection of the submit button 570 in FIG. 5.

The configuration file is selected from the configuration file list displayed on the CM UI S742. Referring to FIG. 6, Configuration File 610 is displayed as having been selected in CM UI 600 and includes UHN of UHN123 612.

The configuration file selected from the configuration file list displayed on the CM UI is sent to the CM and to trigger the CM to initiate the configuration push of the configuration file to the network function device to begin configuring the network function device S746. Referring to FIG. 6, upload icon 650 allows a user to upload Configuration File 610 having UHN of UHN123 612 to CM. Selection of the Upload Icon 650 initiates the configuration push of the configuration file to the network element.

Configuration status information about the configuration of the network function device is displayed on the CM UI in response to the configuration push of the configuration file by the CM to the network function device S750.

Referring to FIG. 3, the CM UI 314 displays the status of the configuration process, e.g., whether the configuration was successful, and whether the configuration failed. Feedback about actions the user is able to take to complete the configuration are also displayed. Referring to FIG. 4, CM UI 400 shows for Configuration File 470 that the Day 1 Configuration Status is Failure 480, the Day 2 Configuration Status is Pending 482, and the Data Model Type identifier is XML 484. Thus, the user is able to visualize from CM UI 400 the status of the configuration process, e.g., whether the configuration was successful, whether the configuration failed, or whether the configuration push has particular issues or reasons for failure.

The process then ends S760.

At least one embodiment for enabling a user to initiate a configuration push by a configuration manager includes accessing a configuration manager (CM) User Interface (UI), determining a network function device to configure, providing a configuration file for configuring the network function device to the CM using the CM UI, and initiating, using the CM UI, a configuration push of the configuration file by the CM to the network function device to begin configuring the network function device.

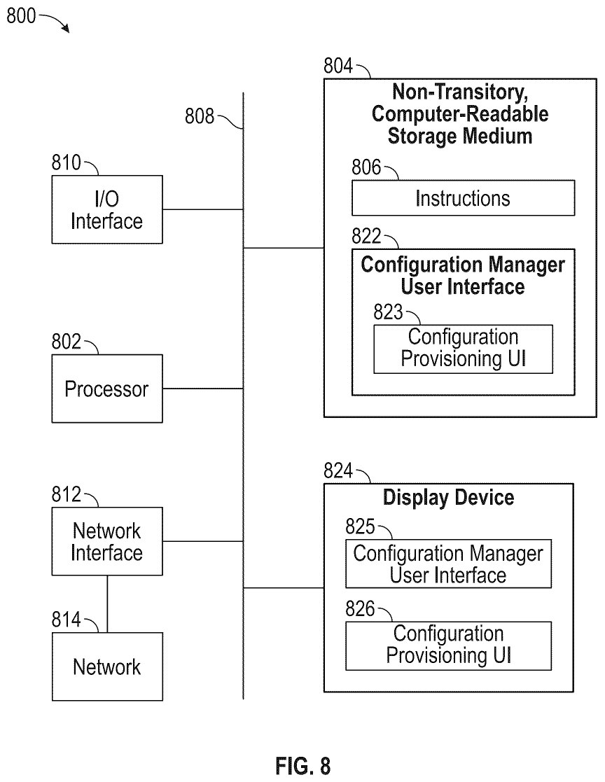

FIG. 8 is a high-level functional block diagram of a processor-based system 800 according to at least one embodiment.

In at least one embodiment, processing circuitry 800 provides end-to-end application onboarding. Processing circuitry 800 implements configuration file generation and user initiated configuration push to a network device using processor 802. Processing circuitry 800 also includes a non-transitory, computer-readable storage medium 804 that is used to implement configuration file generation and a user initiated configuration push to a network device. Storage medium 804, amongst other things, is encoded with, i.e., stores, instructions 806, i.e., computer program code that are executed by processor 802 causes processor 802 to perform operations for configuration file generation and a user initiated configuration push to a network device. Execution of instructions 806 by processor 802 represents (at least in part) implementation of at least a portion of the methods described herein in accordance with one or more embodiments (hereinafter, the noted processes and/or methods).

Processor 802 is electrically coupled to computer-readable storage medium 804 via a bus 808. Processor 802 is electrically coupled to an Input/output (I/O) interface 810 by bus 808. A network interface 812 is also electrically connected to processor 802 via bus 808. Network interface 812 is connected to a network 814, so that processor 802 and computer-readable storage medium 804 connect to external elements via network 814. Processor 802 is configured to execute instructions 806 encoded in computer-readable storage medium 804 to cause processing circuitry 800 to be usable for performing at least a portion of the processes and/or methods. In one or more embodiments, processor 802 is a Central Processing Unit (CPU), a multi-processor, a distributed processing system, an Application Specific Integrated Circuit (ASIC), and/or a suitable processing unit.

Processing circuitry 800 includes I/O interface 810. I/O interface 810 is coupled to external circuitry. In one or more embodiments, I/O interface 810 includes a keyboard, keypad, mouse, trackball, trackpad, touchscreen, and/or cursor direction keys for communicating information and commands to processor 802.

Processing circuitry 800 also includes network interface 812 coupled to processor 802. Network interface 812 allows processing circuitry 800 to communicate with network 814, to which one or more other computer systems are connected. Network interface 812 includes wireless network interfaces such as Bluetooth, Wi-Fi, Worldwide Interoperability for Microwave Access (WiMAX), General Packet Radio Service (GPRS), or Wideband Code Division Multiple Access (WCDMA); or wired network interfaces such as Ethernet, Universal Serial Bus (USB), or Institute of Electrical and Electronics Engineers (IEEE) 864.

Processing circuitry 800 is configured to receive information through I/O interface 810. The information received through I/O interface 810 includes one or more of instructions, data, design rules, libraries of cells, and/or other parameters for processing by processor 802. The information is transferred to processor 802 via bus 808. Processor 802 is configured to receive information related to Configuration Manager (CM) User Interface (UI) 822 through I/O interface 810. Processor 802 is also configured to receive information related to Configuration Provisioning UI 823 through I/O interface 810. The information related to CM UI 822 and to Configuration Provisioning UI 823 is stored in computer-readable medium 804 as CM UI 822. Processor 802 accesses the information related to CM UI 822 and the information related to Configuration Provisioning UI 823 to present CM UI 825 and Configuration Provisioning UI 826, respectively, on Display Device 824 as described above with reference to FIGS. 3-7.

In one or more embodiments, one or more non-transitory computer-readable storage media 804 having stored thereon instructions (in compressed or uncompressed form) that may be used to program a computer, processor, or other electronic device) to perform processes or methods described herein. The one or more non-transitory computer-readable storage media 804 include one or more of an electronic storage medium, a magnetic storage medium, an optical storage medium, a quantum storage medium, or the like. For example, the computer-readable storage media may include, but are not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. In one or more embodiments using optical disks, the one or more non-transitory computer-readable storage media 804 includes a Compact Disk-Read Only Memory (CD-ROM), a Compact Disk-Read/Write (CD-R/W), and/or a Digital Video Disc (DVD).

In one or more embodiments, storage medium 804 stores computer program code 806 configured to cause processing circuitry 800 to perform at least a portion of the processes and/or methods for configuration file generation and a user initiated configuration push to a network device. In one or more embodiments, storage medium 804 also stores information, such as algorithm which facilitates performing at least a portion of the processes and/or methods for configuration file generation and a user initiated configuration push to a network device. Accordingly, in at least one embodiment, the processor circuitry 800 performs a method for enabling a user to initiate a configuration push by a configuration manager. The process includes accessing a configuration manager (CM) User Interface (UI), determining a network function device to configure, providing a configuration file for configuring the network function device to the CM using the CM UI, and initiating, using the CM UI, a configuration push of the configuration file by the CM to the network function device to begin configuring the network function device. The process for enabling a user to initiate a configuration push by a configuration manager provides the advantages of saving time, reducing user effort, and minimizing or reducing cost involved in configuring a network service or device. Users do not depend on an orchestrator to trigger a configuration push of a configuration file to the network service or device. Users are able to trigger the configuration push using a Configuration Manager (CM) User Interface (UI). Separate instances of these programs can be executed on or distributed across any number of separate computer systems. Thus, although certain steps have been described as being performed by certain devices, software programs, processes, or entities, this need not be the case. A variety of alternative implementations will be understood by those having ordinary skill in the art.

Additionally, those having ordinary skill in the art readily recognize that the techniques described above can be utilized in a variety of devices, environments, and situations. Although the embodiments have been described in language specific to structural features or methodological acts, the subject matter defined in the appended claims is not necessarily limited to the specific features or acts described. Rather, the specific features and acts are disclosed as exemplary forms of implementing the claims.

What is claimed is:

1. A method for enabling a user to initiate a configuration push by a configuration manager, comprising:
accessing a configuration manager (CM) User Interface (UI);
determining a network function device to configure;
providing a configuration file for configuring the network function device to the CM using the CM UI; and
initiating, using the CM UI, a configuration push of the configuration file by the CM to the network function device to begin configuring the network function device.

2. The method of claim 1, wherein the providing the configuration file for configuring the network function device to the CM includes selecting on the CM UI to add the configuration file, in response to selecting to add the configuration file, displaying a Configuration Provisioning UI, and uploading the configuration file using the Configuration Provisioning UI, the configuration file being displayed on the CM UI in response to the configuration file being uploaded.

3. The method of claim 1, wherein the providing the configuration file for configuring the network function device to the CM includes selecting on the CM UI to add the configuration file, and in response to selecting to add the configuration file, displaying a Configuration Provisioning UI, wherein the Configuration Provisioning UI is used to:
set configuration parameters for configuring the network function device using a dynamic parameter sheet or a template,
create the configuration file based on the configuration parameters set using the dynamic parameter sheet or the template, and
upload the configuration file created using the Configuration Provisioning UI, the configuration file created using the Configuration Provisioning UI being displayed on the CM UI in response to the configuration file created using the Configuration Provisioning UI being uploaded.

4. The method of claim 1 further comprising displaying, on the CM UI, configuration status information about the configuration of the network function device in response to the configuration push of the configuration file by the CM to the network function device.

5. The method of claim 4, wherein the displaying, on the CM UI, configuration status information includes displaying a first indication of success in configuring the network function device, a second indication of failure in configuring the network function device, or at least one indication of a reason for the failure in configuring the network function device and an action to take to address the failure.

6. The method of claim 1, wherein the providing the configuration file for configuring the network function device to the CM includes:
displaying a Configuration Provisioning UI having at least one input window for setting at least one parameter associated with the configuration file; and
receiving input of the at least one parameter associated with the configuration file using the at least one input window on the Configuration Provisioning UI;
wherein the Configuration Provisioning UI is displayed in response to selecting on the CM UI to add or edit the configuration file.

7. The method of claim 1, wherein the initiating, using the CM UI, the configuration push of the configuration file by the CM to the network function device to configure the network device includes:
selecting the configuration file from a configuration file list displayed on the CM UI; and
receiving a selection on the CM UI to upload the configuration file selected from the configuration file list displayed on the CM UI, the receiving the selection on the CM UI to upload the configuration file sending the configuration file to the CM and triggering the CM to initiate the configuration push of the configuration file to the network function device to begin configuring the network function device.

8. A device for enabling a user to initiate a configuration push by a configuration manager, comprising:
a memory storing computer-readable instructions; and
a processor connected to the memory, wherein the processor is configured to execute the computer-readable instructions to:
display a configuration manager (CM) User Interface (UI);
receiving input identifying a network function device to configure;
provide configuration file for configuring the network function device to the CM based on input provided to the CM UI; and
initiate, from input received on the CM UI, a configuration push of the configuration file by the CM to the network function device to begin configuring the network function device.

9. The device of claim 8, wherein the processor provides the configuration file for configuring the network function device to the CM by:
receiving a selection on the CM UI to add the configuration file;
in response to receiving the selection to add the configuration file, displaying a Configuration Provisioning UI; and
uploading the configuration file using the Configuration Provisioning UI, the processor displaying the configuration file on the CM UI in response to the configuration file being uploaded.

10. The device of claim 8, wherein the processor provides the configuration file for configuring the network function device to the CM by:
receiving a selection on the CM UI to add the configuration file; and
in response to receiving the selection to add the configuration file, displaying a Configuration Provisioning UI,
wherein the processor is further configured to receive, on the Configuration Provisioning UI, input to set configuration parameters for configuring the network function device using a dynamic parameter sheet or a template, create the configuration file based on the configuration parameters input on the Configuration Provisioning UI using the dynamic parameter sheet or the template, upload the configuration file created using the Configuration Provisioning UI; and display the configuration file created using the Configuration Provisioning UI on the CM UI in response to the configuration file being uploaded.

11. The device of claim 8, wherein the processor is further configured to display, on the CM UI, configuration status information about the configuration of the network function device in response to the configuration push of the configuration file by the CM to the network function device.

12. The device of claim 11, wherein displaying, on the CM UI by the processor, configuration status information further includes displaying a first indication of success in configuring the network function device, a second indication of failure in configuring the network function device, or at least one indication of a reason for the failure in configuring the network function device and an action to take to address the failure.

13. The device of claim 8, wherein the processor provides the configuration file for configuring the network function device to the CM by:
displaying a Configuration Provisioning UI having at least one input window for receiving at least one parameter associated with the configuration file; and
receiving input of the at least one parameter associated with the configuration file via the at least one input window on the Configuration Provisioning UI;
wherein the processor displays the Configuration Provisioning UI in response to selecting on the CM UI to add or edit the configuration file.

14. The device of claim 8, wherein the processor initiates the configuration push of the configuration file by the CM to the network function device to configure the network device by:
receiving a selection of the configuration file from a configuration file list displayed on the CM UI;
receiving input on the CM UI to upload the configuration file based on receiving the selection of the configuration file from the configuration file list displayed on the CM UI; and
in response to receiving the input on the CM UI to upload the configuration file, sending the configuration file to the CM and triggering the CM to initiate the configuration push of the configuration file to the network function device to begin configuring the network function device.

15. A non-transitory computer-readable media having computer-readable instructions stored thereon, which when executed by a processor causes the processor to perform operations comprising:
accessing a configuration manager (CM) User Interface (UI);
determining a network function device to configure;
providing a configuration file for configuring the network function device to the CM using the CM UI; and
initiating, using the CM UI, a configuration push of the configuration file by the CM to the network function device to begin configuring the network function device.

16. The non-transitory computer-readable media of claim 15, wherein the providing the configuration file for configuring the network function device to the CM includes selecting on the CM UI to add the configuration file, in response to selecting to add the configuration file, displaying a Configuration Provisioning UI, and uploading the configuration file using the Configuration Provisioning UI, the configuration file being displayed on the CM UI in response to the configuration file being uploaded.

17. The non-transitory computer-readable media of claim 15, wherein the providing the configuration file for configuring the network function device to the CM includes selecting on the CM UI to add the configuration file, and in response to selecting to add the configuration file, displaying a Configuration Provisioning UI, wherein the Configuration Provisioning UI is used to:
set configuration parameters for configuring the network function device using a dynamic parameter sheet or a template,
create the configuration file based on the configuration parameters set using the dynamic parameter sheet or the template, and
upload the configuration file created using the Configuration Provisioning UI, the configuration file created using the Configuration Provisioning UI being displayed on the CM UI in response to the configuration file created using the Configuration Provisioning UI being uploaded.

18. The non-transitory computer-readable media of claim 15 further comprising displaying, on the CM UI, configuration status information about the configuration of the network function device in response to the configuration push of the configuration file by the CM to the network function device, wherein the displaying, on the CM UI, configuration status information includes displaying a first indication of success in configuring the network function device, a second indication of failure in configuring the network function device, or at least one indication of a reason for the failure in configuring the network function device and an action to take to address the failure.

19. The non-transitory computer-readable media of claim 15, wherein the providing the configuration file for configuring the network function device to the CM includes:
displaying a Configuration Provisioning UI having at least one input window for receiving at least one parameter associated with the configuration file; and
receiving input of the at least one parameter associated with the configuration file using the at least one input window on the Configuration Provisioning UI;
wherein the Configuration Provisioning UI is displayed in response to selecting on the CM UI to add or edit the configuration file.

20. The non-transitory computer-readable media of claim 15, wherein the initiating, using the CM UI, a configuration push of the configuration file by the CM to the network function device to configure the network device includes:
selecting the configuration file from a configuration file list displayed on the CM UI; and
receiving a selection on the CM UI to upload the configuration file selected from the configuration file list displayed on the CM UI, the receiving the selection on the CM UI to upload the configuration file sending the configuration file to the CM and triggering the CM to initiate the configuration push of the configuration file to the network function device to begin configuring the network function device.
